(19) United States
(12) Patent Application Publication
(10) Pub. No.: US 2018/0348039 A1
(43) Pub. Date: Dec. 6, 2018

(54) RADAR LEVEL GAUGE

(71) Applicant: Rosemount Tank Radar AB, Molnlycke (SE)

(72) Inventor: Mikael Kleman, Ulrika (SE)

(21) Appl. No.: 15/612,139

(22) Filed: Jun. 2, 2017

(51) Int. Cl. G01F 23/28; G01S 7/40

(52) U.S. Cl. CPC G01F 23/282; G01S 7/4004

(57) ABSTRACT

A radar level gauge for determining a filling level of a product in a tank, comprising a volatile high-speed working memory, a first processing unit connected to the volatile high-speed working memory, the first processing unit having an active mode in which the first processing unit is turned on and accesses the working memory, and an inactive mode where the first processing unit is turned off, memory loading functionality, configured to transfer software code from a non-volatile memory into the volatile high-speed working memory, wherein the memory loading functionality is further configured to divide the software code into a plurality of smaller portions, and transfer one such smaller portion at a time.

By dividing the software code which is to be transferred into a plurality of smaller portions, the energy required to complete transfer of one such smaller portion can be sufficiently small to allow energy storage capacity of feasible size and cost.

### FIELD OF THE INVENTION

The present invention relates to a radar level gauge (RLG).

### BACKGROUND OF THE INVENTION

A recent generation of automotive radar systems include a 77 GHz radar transceiver in combination with suitable processing circuitry. Such systems are adapted to receive power from a 12 V battery supply, and to have a relatively high measurement update rates, e.g. in the order of 10 or even 100 measurements per second. In order to obtain sufficiently fast processing, software code as well as data is stored in a fast (but volatile) memory, such as SRAM. The software code is loaded from a non-volatile memory (e.g. a flash memory) into the SRAM using a boot-loader executed by the processor at each start-up of the system. A typical start-up time is around one second.

Such radar systems typically have a relatively broad bandwidth, e.g. at least one GHz. This makes them potentially useful in the technical field of in radar level gauging in tanks or other containers, where a bandwidth of 1 GHz or more is normally required to obtain sufficient resolution and accuracy. As these systems are intended for the automotive industry, the manufacturing volumes are very large, whereby manufacturing cost can be kept low. It would thus be beneficial if such systems could be used for radar level gauging, e.g. for monitoring the level of fluids or solids in tanks or other containers.

It is noted that mass produced radar systems, e.g. for the automotive industry, is not a new concept. However, previously available systems have operated in other frequency ranges, e.g. in the 24 GHz area, where only a limited bandwidth is publicly available, i.e. allowable from a regulatory perspective. Therefore, such previously available radar systems, although similarly beneficial from a cost perspective, have had insufficient band width for high performance radar level gauging.

However, the requirements of a RLG radar system are significantly different from those of an automotive system. In particular, different aspects of energy consumption are of critical importance. While a radar system in a car typically has more or less unlimited power from a 12 V source, many radar level gauges are powered by energy scavenged from a two-wire control loop, e.g. a 4-20 mA control loop, in which case the available power in worst case is limited to a few tens of mW. For example, at a low control current of 4 mA, and with a usable voltage of around 10 V, makes only 40 mW available to power the RLG. Energy storage is conventionally used in an RLG to periodically provide higher power for fractions of each one of the consecutive measurement cycles, but with a typical update rate in the order of one measurement per second or higher, the total energy available for a measurement cycle is also very limited. Another category of radar level gauges are battery powered, in which case the available power may be greater, but instead energy consumption must be minimized in order to ensure a satisfactory life-time of the battery.

If using a radar system according to the above in a RLG, these restrictions on energy consumption introduce a few specific challenges:

1) The radar system must be shut down between each measurement in order to save power and accumulate energy. As a consequence, any start-up procedure thereof, such as transfer of the software code to the fast memory (SRAM) must be repeated for each measurement, thereby reducing the update rate below what is acceptable.

2) The energy required to transfer the software code from a non-volatile memory to the fast memory is typically in the order of 100 mWs, for example around 400 mWs. Even if such an amount of energy may be scavenged from a 4-20 mA control loop (given sufficient time), it would require a significant amount of energy storage capacity. Such energy storage capacity will be associated with a large circuit board area and a substantial cost.

### GENERAL DISCLOSURE OF THE INVENTION

It is a general object of the present invention to address these challenges, and to provide a radar level gauge having circuitry suitable for mass production yet adapted for the specific requirements on power and energy consumption.

For example, if radar systems intended to be produced in very large volumes for the automotive market can be adapted for use in radar level gauges, it would represent significant advantages with respect to cost and space.

According to a first aspect of the invention, this and other objects are achieved by a radar level gauge for determining a filling level of a product in a tank, the radar level gauge comprising transceiver circuitry configured to generate and transmit an electromagnetic transmit signal, and to receive an electromagnetic return signal; and processing circuitry connected to the transceiver circuitry and configured to determine the filling level based on a relationship between the transmit signal and the return signal, a temporary energy store for storing energy from an energy source selected as at least one of: a power-limited power interface and a localized energy-limited energy source, power management circuitry configured to distribute power from the energy store to the transceiver circuitry and the processing circuitry, and communication circuitry connected to receive measurement data from the processing circuitry and to communicate the measurement data externally of the radar level gauge. The processing circuitry includes a volatile high-speed working memory, a first processing unit connected to the volatile high-speed working memory, the first processing unit having an active mode in which the first processing unit is turned on and accesses the working memory, and an inactive mode where the first processing unit is turned off, memory loading functionality, configured to transfer software code from a non-volatile memory into the volatile high-speed working memory, wherein the memory loading functionality is further configured to divide the software code into a plurality of smaller portions, and transfer one such smaller portion at a time.

By dividing the software code which is to be transferred into a plurality of smaller portions, the energy required to complete transfer of one such smaller portion can be sufficiently small to allow energy storage capacity of feasible size and cost.

As mentioned above, the total energy required to transfer the required software code using a processor-run boot loader may be as large as 400 mWs. By dividing this software code into 40 smaller portions, energy storage in the order of 10 mWs will be sufficient.

In some embodiments, it may be possible to preserve the contents of the working memory between measurement cycles. However, a transfer of code will still need to take place, for example the very first time a RLG is powered up, or after a complete disconnection of power. For this reason, it may be advantageous if the processing circuitry is further configured to perform a verification of the working memory in the beginning of each measurement cycle, and, if the working memory content is incomplete or not intact, initiate the transfer of software code from a non-volatile memory to said working memory. Such functionality will allow the processing circuitry to follow the same start-up procedure at all times. If it is determined that transfer of code is required, such transfer will be initiated. If not, the measurement cycle will start.

According to one embodiment, the working memory has a memory preserving low power mode during periods when the first processing unit is in inactive mode, and the auxiliary power connection is configured to provide power to the volatile high-speed working memory from the power management circuitry during the low power mode, and the processing circuitry is designed to reduce any leakage currents from the volatile high speed memory to other parts of the processing circuitry in the memory preserving low power mode.

It is previously known to provide a volatile working memory, such as an SRAM, with a memory preserving low power mode. By providing an auxiliary power connection to the working memory, continuous power supply of the working memory can be ensured also when the first processing unit is turned off. However, if the working memory is integrated on the same integrated circuit as the first processing unit, the power consumption of such a memory preserving low power mode is increased and may be too high to be feasible for an RLG application.

A significant part of such power consumption may be caused by leakage currents from the working memory to other parts of the circuitry, such as the first processing unit. By preventing any leakage currents from the working memory, the power consumption in the memory preserving low power mode can be reduced to a minimum, thereby making it feasible to maintain the memory of the high speed working memory between measurements in an RLG application.

According to one embodiment, the memory loading functionality includes a memory loading circuitry, separate from the processing unit, configured to transfer the software code from the non-volatile memory into the volatile high-speed working memory while the processor is in inactive mode, and an externally accessible power supply connection configured to provide power only to the volatile high-speed working memory and the memory loading circuitry.

With this design, the memory loading circuitry and working memory can be powered separately, thereby allowing loading of software code from the non-volatile memory into the volatile high-speed working memory without activating the relatively power-hungry processor.

As mentioned above, in integrated circuits for automotive applications the transfer of software code from a non-volatile memory to the working memory is performed by a boot-loader implemented by the processor (CPU). In other words, the relatively power-hungry processor must be active throughout the memory transfer. By performing the memory transfer using separate circuitry, powered by a separate power supply, power consumption during memory transfer can be significantly reduced.

For example, and as mentioned above, the total energy required to transfer the required software code using a processor-run boot loader may be as large as 400 mWs. By implementing a memory loading circuitry according to the invention, with significantly lower power consumption, the total energy required to transfer the required software may be reduced to be in the order of 50 mWs.

It is noted that if the available power is in the order of 10 mW (which is a typical worst case for a RLG powered by scavenging a 4-20 mA control loop), the time required to transfer the memory will be reduced to around five seconds, compared to more than 30 seconds with a processor executed boot-loader.

According to some embodiments, the transceiver circuitry is configured to provide multi-channel transmission and reception. Multiple channels enable controlling the direction of the transmission and/or reception lobe of a directional antenna connected to the transceiver. Such directivity control is critical in many automotive applications, and may be beneficial also in radar level gauging.

In some embodiments, the transceiver circuitry is configured to operate in a frequency range above 75 GHz, e.g. 76-77 GHz, 76-79 GHz or 77-81 GHz.

It is noted that operation in these mentioned frequency ranges is not necessarily a limitation of the present invention. However, as mentioned above, in this part of the frequency spectrum the frequency band which has been made available to the public is in most geographical areas sufficient for high performance radar level gauging.

The transceiver circuitry and processing circuitry may be implemented as separate chips on a common board. However, in order to reduce size and improve environmental impact, it is generally desirable to integrate the transceiver circuitry and processing circuitry in a single integrated circuit (IC), either as a monolithic IC or as a hybrid multichip IC. Another positive effect of such integration is that communication between the digital side of the transceiver circuitry and the processing circuitry can be performed fast and efficiently. It is noted that commercial offerings of such highly integrated radar systems in the 77 GHz area have existed for some time.

### BRIEF DESCRIPTION OF THE DRAWINGS

The present invention will be described in more detail with reference to the appended drawings, showing currently preferred embodiments of the invention.

FIG. 1a shows a schematic block diagram of a radar level gauge connected to a two-wire control loop according to an embodiment of the present invention.

FIG. 1b shows a schematic block diagram of a battery powered radar level gauge according to an embodiment of the present invention.

FIG. 2 is a flow chart illustrating a method for verification of working memory contents according to an embodiment of the invention.

FIG. 3 is a flow chart illustrating a method for memory transfer according to an embodiment of the invention.

FIG. 4 is a flow chart illustrating a further method for memory transfer according to an embodiment of the invention.

### DETAILED DESCRIPTION OF PREFERRED EMBODIMENTS

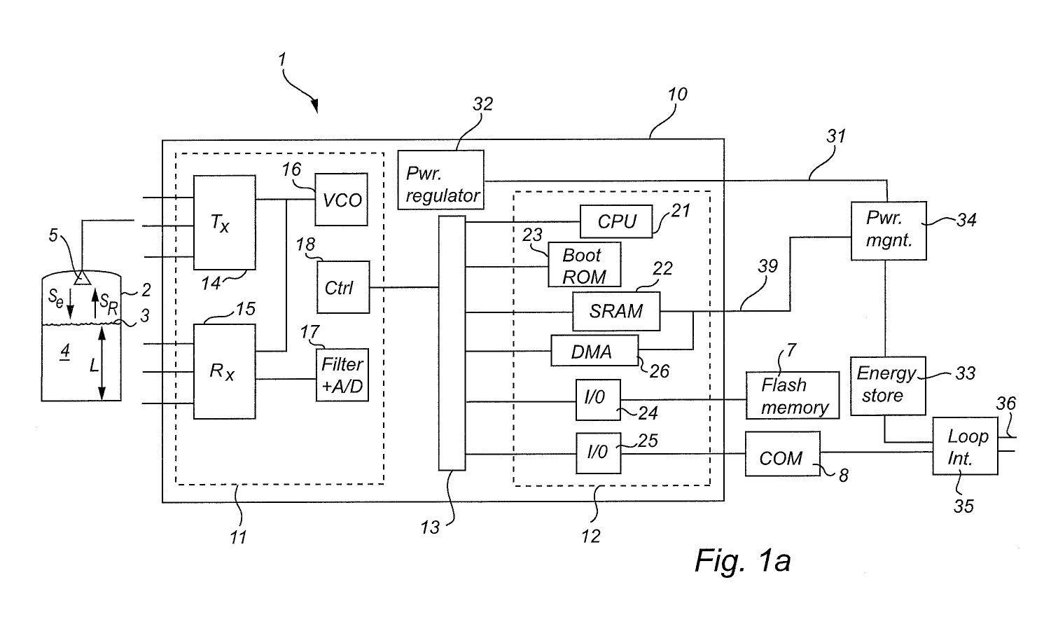

FIGS. 1a and 1b show very schematically a radar level gauge (RLG) 1 which can be mounted on the roof of a tank 2 in order to measure a distance to a surface 3 of a product 4 kept in the tank. The distance can be used to determine a process variable, such as the filling level L of the tank.

The RLG 1 has a signal propagation device, here a directional antenna 5, arranged to emit a transmit signal S_{T} into the tank 2 and to receive a reflected signal S_{R} from the tank. The antenna 5 is connected to a radar unit 10, including transceiver circuitry 11 and processing circuitry 12. Further details of the radar unit 10 will be further discussed below. The radar unit 10 is connected to a non-volatile memory, such as a flash memory, 7, and to communication circuitry 8.

In order to communicate the detected process variable outside the RLG 1, the communication circuitry 8 may be connected to a two-wire control loop 37, typically a two-wire 4-20 mA control loop, via a two-wire interface 36 (FIG. 1a). Such two-wire interface could be adapted for other ways of communication and power receipt, for instance, according to Foundation Fieldbus or ProfiBus PA, wherein similar advantages are attainable in accordance with the invention. Alternatively, the communication circuitry 8 may be connected to a wireless communication unit 9 (FIG. 1b).

In FIG. 1a, the RLG 1 is powered by the two-wire interface 36, which is configured to scavenge energy from the control loop 37. In order to periodically allow greater power than what may be available on the control loop, the RLG 1 further includes an energy store 33 connected to the two-wire interface, and also power management circuitry 34 for appropriate distribution of power from the energy store 33.

In FIG. 1b, the RLG 1 is powered by a battery 38 connected to the communication circuitry 20 and to the energy store 33. It is noted that in principle, a battery may be configured to provide sufficient power so that the energy store 33 and power management circuitry 34 may be omitted. In reality, however, long life batteries used for radar level gauges typically have a restriction on peak power which is below that required by the radar unit 10.

The radar unit 10 is similar in functionality to radar systems available for use in the automotive industry, but has been adapted to be compatible with the specific power requirements of radar level gauging. The radar unit 10 described in the following operates according to the frequency modulated continuous wave (FMCW) principle, although other principles may also be contemplated.

As already mentioned, the radar unit 10 includes transceiver circuitry 11 and processing circuitry 12. The circuitry 11 and 12 can communicate with each other, e.g. by means of a shared communication bus 13.

The main parts of the transceiver circuitry 11 are the transmitter 14 and receiver 15. These are analogue radar circuits configured to transmit and receive, respectively, electromagnetic waves typically in the microwave range. In the illustrated case, both transmitter 14 and receiver 15 are multi-channel, i.e. they transmit and receive, respectively, more than one channel. Multiple transmit channels allow varying the direction of the antenna lobe. Similarly, multiple receiver channels allow varying the main direction of reception. Both transmitter and receiver are controlled by a voltage controlled oscillator (VCO) 16 or other suitable oscillator. The signals from the receiver 15 are input to a front end module 17, which includes filters and an A/D-converter to provide a digital signal. A controller 18 is in connection with the communication bus 13, and is configured to control all parts of the transceiver circuitry 11.

The processing circuitry 12 comprises a first processing unit (CPU) 21, and a fast, but volatile memory, here referred to as an SRAM (static random access memory) 22. It is noted that a data access time of the SRAM 21 is typically in the order of 10 ns, which is significantly less than a data access time of the flash memory 7, which is typically in the order of 100 ns.

Further, the circuitry includes a non-volatile boot ROM 23, storing instructions to enable booting (start-up) of the CPU 21. The circuitry 12 also includes at least one I/O port. In the illustrated case, the circuitry 12 includes two serial ports 24, 25, one intended to be connected to a nonvolatile memory such as a flash memory, and the other intended to be used as a data communication port. For example, the I/O ports may include a serial peripheral interface (SPI) for communicating with the communication circuitry 8, and a quad serial peripheral interface (QSPI) for communicating with the flash memory 7. The CPU 21, SRAM 22, ROM 23 and I/O-ports 24, 25 are sometimes referred to as a micro controller unit (MCU).

Optionally, the circuitry 12 further includes a memory loading module, here referred to as a direct memory access (DMA) module 26, which is configured to enable direct transfer of data from the first I/O port 24 to the SRAM 22. The operation of such a memory loading module will be explained below.

The transceiver circuitry 11 and processing circuitry 12 are both powered by a common power rail 31, via suitable power regulation and distribution circuitry 32. As briefly mentioned above, in order to provide sufficient power to the relatively power hungry radar system 10, the RLG 1 includes an energy store 33 and power management circuitry 34. The energy store 33 is configured to store energy from a low power energy source, which may be used by the power management circuitry during a short period of time to temporarily provide a higher power. As briefly mentioned above, the energy to the energy store 33 may come from the two-wire control loop interface 35 (FIG. 1a) connected to a two-wire control loop 36, e.g. a 4-20 mA current control loop, or from the battery 37 (FIG. 1b).

In operation, in this case based on the FMCW principle, the controller 18 controls the VCO to generate a frequency sweep across the operating range of the system. As an example, the operating range may be 76-77 GHz. The generated frequency sweep is transmitted by the transmitter 14 as a transmit signal S_{T} to the antenna 5, which emits the transmit signal into the tank 2. The signal S_{T} is reflected by the surface 3 and the reflection is received by the antenna as a reflection signal S_{R}. The reflection signal is received in the receiver 15 where it is mixed with the transmit signal to obtain an intermediate frequency (IF) signal. The frequency of the IF signal is proportional to the electrical distance from the transceiver 11 to the surface 3. The IF signal is filtered and ND-converted by the front end module 17, and then communicated to the processing circuitry 12 via the bus 13.

The processing circuitry 12 determines the relevant process variable, typically the filling level L of the tank, and this measurement value is output to the communication circuitry 8 and further to the two-wire control loop 37 (FIG. 1a) or to the wireless communication unit 9 (FIG. 1b).

In order to enable very fast processing, the processing circuitry 12 is configured to use the fast (but volatile) working memory 22 for data and software code. In order to save energy, however, the RLG 1 will need to shut down the radar unit 10, or at least minimize its power consumption, between each measurement which are performed with an update frequency of e.g. one Hz, i.e. measurements once a second. Most importantly, the CPU 21 is placed in an inactive mode between measurements, in which mode it consumes less than 5% of the power compared to active operation. In some situations, the power consumption is reduced to less than 1% or even less than 0.1% of normal consumption.

One practical way to shut down the radar unit 10 is to interrupt the power supply on the main power supply 31. In order to allow the memory 22 to maintain its content also during periods between measurements, when the radar unit 10 is shut down, the radar unit 10 is here provided with an auxiliary power connection 39. This auxiliary power connection is connected directly to the working memory (here SRAM) 22, to provide power also during periods when the main power supply 31 is disconnected.

The working memory 22 is configured to have two modes. In a first normal operating mode, the working memory 22 is accessed by the CPU 21 via the bus 13 to perform read and write operations. In a second, memory preserving mode, the working memory 22 simply maintains the states (1/0) of all its memory cells. In the second mode, the power drawn by the working memory is significantly smaller, and it is this lower power that is provided by the dedicated power connection 39.

The power drawn by the working memory in its second mode is essentially determine by leakage currents in the memory 22 itself, and between the memory 22 and the bus 13. In order to keep this power sufficiently low, design of the working memory 22 and its connection with bus 13 needs to be chosen to reduce leakage currents as far as possible.

Techniques for such leakage current reduction in SRAM are known in the art per se, and constantly being improved in order to reduce power consumption in various applications, such as mobile phones. As an example, reference is made to the article “Reliable techniques of leakage current reduction for SRAM-6T Cell: A review”, by D. S. Chauhan, presented on 3rd International Conference on Computing for Sustainable Global Development (INDIACom), 16-18 Mar. 2016.

The power management circuitry 34 is here configured to provide power on the main power rail 31 during a measurement cycle when the radar unit 10 is active. It is noted that the power drawn from the energy store 33 will vary during this the measurement cycle, and typically have a peak when the transceiver circuitry is active, and then fall to a slightly lower level when only the processing circuitry is active. Between measurement cycles, when the radar unit 10 is inactive, the power management circuitry 34 is further configured to power down the main power rail 31 (i.e. not provide any power to the rail 31) and to instead provide a significantly lower power to the auxiliary power connection 39. Through this design, the SRAM 22 is able to preserve its content between measurement cycles at minimum power consumption.

Even if the contents of the working memory 22 thus may be preserved when the radar unit 10 is inactive, the software code of the RLG 1 will still need to be loaded into the working memory 22 at an initial system start-up. In order to distinguish between such an initial start-up and just another measurement cycle in a series of measurement cycles, the RLG 1 needs to be configured to perform a verification of the working memory in the beginning of each measurement cycle.

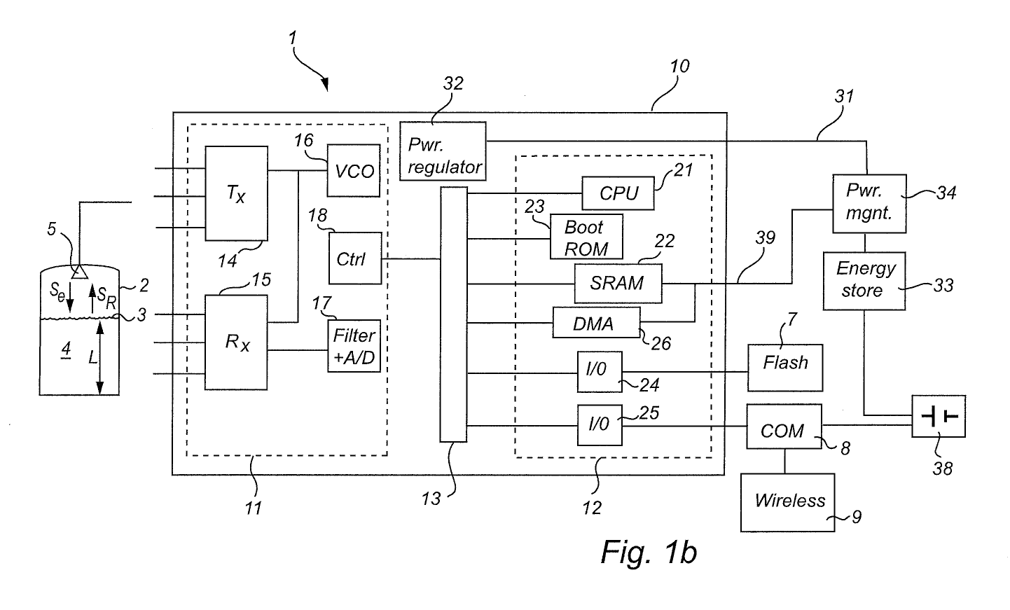

One option is to include software implementing such a memory verifier in the boot ROM 23. Another option could be to program the boot-ROM 23 to load the memory verifier from the flash memory 7 at each start-up. With reference to FIG. 2, at each start-up of the CPU 21 (i.e. upon initial start-up as well as after each idle period between measurements), the CPU 21 will read the memory verifier from the boot-ROM 23 (or from flash 7) (step S1), and by executing this code the CPU 21 will verify the contents of the SRAM 22 (step S2). If the verification reveals that the contents of the SRAM is incomplete in any way, the CPU will initiate a memory loading process (step S3). If the SRAM 22 is fully loaded, the memory verifier instructs the CPU 21 to proceed with running the RLG software stored in the SRAM 22 and thus performing a measurement cycle (step S4).

When the SRAM 22 does need to be loaded (step S3) the power restrictions create another problem. Conventional boot-loaders (i.e. software stored in the boot-ROM and configured to transfer data from the flash memory 7 to the SRAM 22) require more power than what is available from the two-wire loop 36 or from the battery 38. Although sufficient energy in theory could be stored in the energy store 33, such elevated energy storage would require significant amounts of storage capacity, increasing space and cost.

Therefore, the RLG 1 may be provided with dedicated memory loading circuitry, separate from the CPU 21. In FIGS. 1a and 1b, such circuitry is illustrated as a Direct Memory Access (DMA) 26. The DMA 26 is connected to the auxiliary power supply 39, making it possible to power the DMA 26 together with the SRAM 22.

The DMA 26 is configured to access the flash memory 7 and SRAM 22 via the bus 13, and to transfer software code (and other data) from the flash memory 7 to the SRAM 22. Such memory transfer may thus be performed without powering any other parts of the radar unit 10, and in particular without powering the CPU 21.

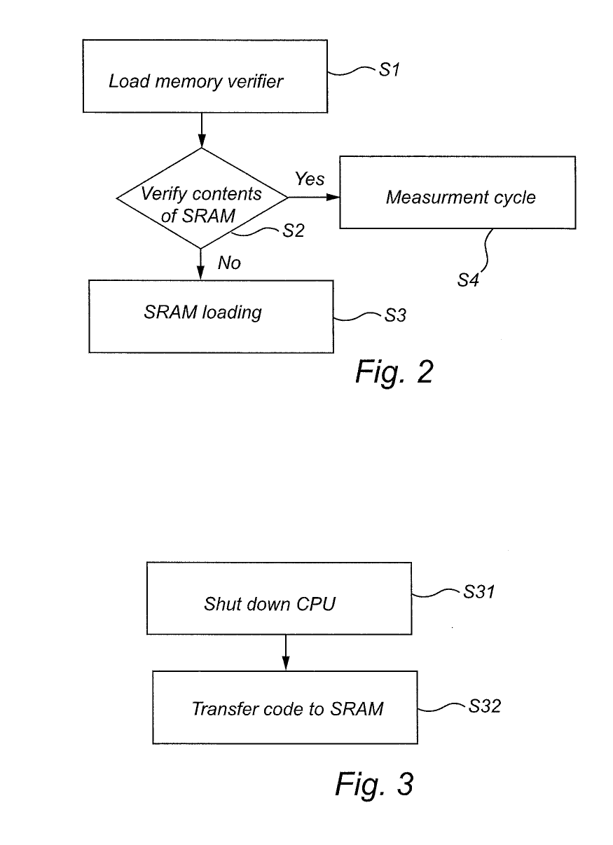

More specifically, and with reference to FIG. 3, the CPU 21 is shut down to minimize power consumption (step S31, which is the first step of step S3 in FIG. 2). It is here noted that even though the CPU 21 is shut down, clock signals are still required for the serial port 24 and DMA 26 to work. Then, in step S32, the DMA 26 is initiated to effect the transfer of code (and any other data) from the flash memory 7 to the SRAM 22.

An alternative option to a separate memory loading circuitry such as the DMA 26, is to divide the code (and other data) to be transferred from the flash memory 7 to the SRAM 22 into a plurality of smaller portions. This may be achieved by reprogramming the boot-loader software stored in the boot-ROM 23. Another option could be to let the “conventional” boot-loader load the adapted boot-loader from flash 7 each time a code transfer should take place.

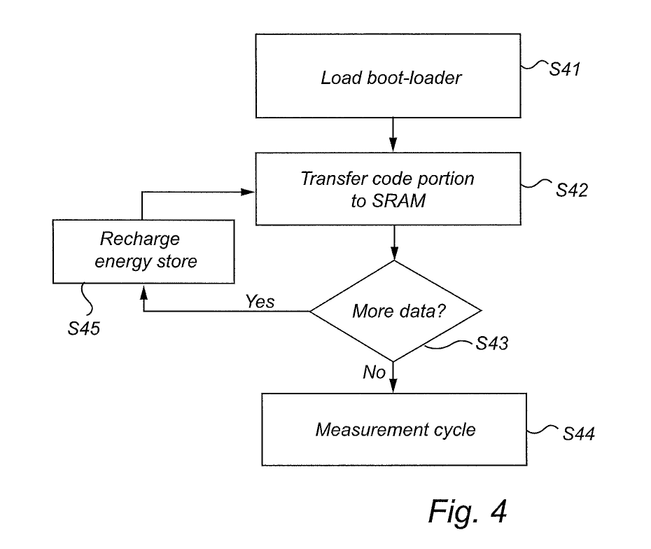

With reference to FIG. 4, an embodiment of such a method is disclosed. First, in step S41, which is the first step of step S3 in FIG. 2, the CPU 21 accesses and executes the boot-loader software. In step S42, the boot-loader then transfers a portion of the code in the flash memory 7 to the SRAM via the bus 13. The size of the portion may be predefined based on system specifications, in particular the amount of energy storage available in the energy store 33. In step S43 the boot-loader checks if there is any code (or other data) remaining in the flash memory 7, and if so returns to step S42 to load another portion. Before that is possible, however, the energy store 33 must be recharged to full capacity in step S45. When there is no more data to transfer, the boot loader instructs the CPU 21 to proceed with running the RLG software stored in the SRAM 22 and thus performing a measurement cycle (step S44, equivalent to step 4 in FIG. 2).

It is noted that the power management circuitry 34 as well as the communication circuitry 8 may be implemented in a second micro controller unit (MCU), which is always operational. This second MCU thus serves as the central “brain” of the RLG, and controls the various processes of power control and code transfer disclosed herein.

The person skilled in the art realizes that the present invention by no means is limited to the preferred embodiments described above. On the contrary, many modifications and variations are possible within the scope of the appended claims. For example, the details of the circuitry may be different, while still implementing the methods of the present invention. Also, some functions described here as implemented in hardware, may be implemented in software and vice versa. Further, it appears that it could be possible and advantageous for the different phases in a measurement cycle to be performed sequentially and/or to some extent overlapping. The communication of a measurement value may take place constantly and any update thereof may take place out of sequence with the phases of the measurement cycle. Steps of the energy accumulation phase could possibly be performed out of sequence with the phases and could possibly provide stored energy just enough for performing any steps required or desirable before a subsequent set of steps of the energy accumulation phase is performed.

Two other US Patent Applications entitled RADAR LEVEL GAUGE by the same inventor are filed on the same date as the present application. Those two US Patent Applications are incorporated herein in their entirety.

1. A radar level gauge for determining a filling level of a product in a tank, said radar level gauge comprising:
transceiver circuitry configured to generate and transmit an electromagnetic transmit signal, and to receive an electromagnetic return signal; and
processing circuitry connected to the transceiver circuitry and configured to determine the filling level based on a relationship between the transmit signal and the return signal,
a temporary energy store for storing energy from an energy source selected as at least one of: a power-limited power interface and a localized energy-limited energy source,
power management circuitry configured to distribute power from the energy store to said transceiver circuitry and said processing circuitry, and
communication circuitry connected to receive measurement data from the processing circuitry and to communicate said measurement data externally of the radar level gauge,
wherein the processing circuitry includes:
a volatile high-speed working memory,
a first processing unit connected to said volatile high-speed working memory, said first processing unit having an active mode in which the processor is turned on and accesses the working memory, and an inactive mode where said first processing unit is turned off,
memory loading functionality, configured to transfer software code from a non-volatile memory into said volatile high-speed working memory,
wherein said memory loading functionality is further configured to divide said software code into a plurality of smaller portions, and transfer one such smaller portion at a time.

2. The radar level gauge according to claim 1, wherein said processing circuitry is further configured to:
perform a verification of the working memory in the beginning of each measurement cycle, and
if the working memory content is incomplete, initiate said transfer of software code from a non-volatile memory to said working memory.

3. The radar level gauge according to claim 1,
wherein said working memory has a memory preserving low power mode during periods when said first processing unit is in inactive mode,
wherein said auxiliary power connection is configured to provide power to said volatile high-speed working memory from said power management circuitry during said low power mode, and
wherein said processing circuitry is designed to reduce any leakage currents from said volatile high speed memory to other parts of the processing circuitry in said memory preserving low power mode.

4. The radar level gauge according to claim 1, wherein the memory loading circuitry is a software implemented boot-loader executed by the first processing unit.

5. The radar level gauge according to claim 1, wherein the memory loading functionality includes a memory loading circuitry, separate from said first processing unit, configured to transfer said software code from the non-volatile memory into said volatile high-speed working memory while said processor is in inactive mode, and
an externally accessible power supply connection configured to provide power only to said volatile high-speed working memory and said memory loading circuitry.

6. The radar level gauge according to claim 5, wherein the memory loading circuitry is a direct memory access (DMA) circuitry.

7. The radar level gauge according to claim 1, wherein the transfer of each software code portion requires an energy of 20 mWs or less.

8. The radar level gauge according to claim 1, wherein the transceiver circuitry provides multi-channel transmission and reception.

9. The radar level gauge according to claim 1, wherein the transceiver circuitry and processing circuitry are integrated in a single integrated circuit.

10. The radar level gauge according to claim 9, wherein the integrated circuit is a monolithic circuit.

11. The radar level gauge according to claim 1, wherein the transceiver circuitry is configured to operate in a frequency range above 75 GHz.

12. The radar level gauge according to claim 11, wherein the frequency range is one of 76-77 GHz, 76-79 GHz, and 77-81 GHz.

13. The radar level gauge according to claim 1, wherein the power-limited power interface is a two-wire control loop interface.

14. The radar level gauge according to claim 1, wherein the localized energy-limited energy source is a battery.

15. A method in a radar level gauge for measuring a distance to a surface of a product kept in a tank, said method comprising:
arranging in said radar level gauge:
a non-volatile memory having a first random data access time;
a volatile working memory having a second random data access time being a fifth (⅕) or less of said first random data access time; and having at least a working memory operational mode and a working memory power saving mode, said power saving mode enabling saving at least 95% of the power requirement of said operational mode while retaining current working memory contents therein;
a first processing unit having at least a first processing unit operational mode and a first processing unit power saving mode, said power saving mode enables saving at least 90% of the power requirement of said first processing unit operational mode;
said method comprising:
transferring software code from said non-volatile memory to said volatile working memory,
applying a cyclic measuring scheme wherein a measurement cycle includes an energy accumulation phase, a measurement phase, a communication phase;
said energy accumulation phase comprising:
setting said working memory power saving mode and said first processing unit power saving mode;
drawing energy, preferably that needed for performing a complete measurement cycle, from an energy source selected as at least one of: a power-limited power interface and a localized energy-limited energy source;
storing intermediately the energy in a temporary power store, which enables discharge of energy at a higher rate than, preferably at least ten times, that of said energy source;
said measurement phase comprising:
transmitting an electromagnetic transmit signal, via a signal propagation device, towards the surface;
receiving an electromagnetic return signal, via said signal propagation device, reflected at said surface;
determining said distance in said first processing unit, based on a relation between said transmit signal and said return signal, by executing said software code stored in the working memory;
said communication phase comprising:
communicating externally of said radar level gauge a measurement value indicative of said distance, typically involving any change to a most up to date measurement value,
wherein the step of transferring software code from said non-volatile memory to said volatile working memory includes:
dividing said software code into a plurality of smaller software portions,
transferring one smaller software portion, and
preferably repeating the step of transferring one smaller software portion and a set of the steps according to said energy accumulation phase at least once, preferably at least two times, prior to performing said measurement phase.

16. The method according to claim 15, including repeating the step of transferring one smaller software portion and the steps of said energy accumulation phase one time for each smaller software portion prior to performing said measurement phase.

17. The method according to claim 15, wherein the step of transferring software code from said non-volatile memory to said volatile working memory includes:
setting said first processing unit in its first processing unit power saving mode,
providing operating power to a memory loading circuitry, separate from said first processing unit,
using said memory loading circuitry to transfer said software code from the non-volatile memory into said volatile working memory while said first processing unit is in said first processing unit power saving mode.

18. The method according to claim 15, further comprising providing sufficient power to said working memory between consecutive measurement phases to keep it in said working memory power saving mode.

19. The method according to claim 15, further comprising:
performing a verification of the working memory in a beginning of each measurement cycle, and
if the working memory content is incomplete, initiate a transfer of said software code from said non-volatile memory to said working memory.

20. The method according to claim 15, wherein said communication phase further includes:
setting said working memory power saving mode and said first processing unit power saving mode, and
retaining current working memory contents.

21. A radar level gauge according to claim 1, for performing the method of claim 15.
